(19) United States
(12) Patent Application Publication
(10) Pub. No.: US 2016/0339484 A1
(43) Pub. Date: Nov. 24, 2016

(54) TRAY SEALER

(71) Applicant: MULTIVAC Sepp Haggenmüller SE & Co. KG, Wolfertschwenden (DE)

(72) Inventor: Andreas Mader, Dietmannsried (DE)

(21) Appl. No.: 15/159,190

(22) Filed: May 19, 2016

(30) Foreign Application Priority Data
May 21, 2015 (EP) 15168593.0

(51) Int. Cl. B08B 5/02; B65B 51/00; B65B 31/00

(52) U.S. Cl. CPC B08B 5/02; B65B 31/00; B65B 51/00

(57) ABSTRACT

The invention relates to a tray sealer comprising a sealing tool lower part with a tray receptacle and a sealing tool upper part. The tray receptacle comprises a cutting groove being provided circumferentially around each opening for a tray in the tray receptacle. The tray receptacle comprises an inlet opening and an outlet opening each facing the cutting groove for flushing the cutting groove with gas.

### CROSS-REFERENCE TO RELATED APPLICATIONS

This application claims priority to European Patent Application Number 15168593.0 filed May 21, 2015, to Andreas Mader, currently pending, the entire disclosure of which is incorporated herein by reference.

### FIELD OF THE INVENTION

The invention relates to a tray sealer, a method for operating a tray sealer, and a method for cleaning a cutting groove of a tray sealer.

### BACKGROUND OF THE INVENTION

A tray sealer with a tray receptacle is known from EP 1 842 776 A2, where gas can be supplied and discharged via openings in the tray receptacle to modify the atmosphere in a tray filled with a product.

EP 2 641 835 A1 discloses a tray sealer with an optimized sealing tool comprising a gas introduction opening and an evacuation opening, where the two openings are arranged on a common side of the sealing tool in order to achieve a U-shaped flow path without turbulence. For products having small particles on their surfaces like breading crumbs, herbs and spices, the particles can be picked up and carried along by the gas flow. In a region disposed opposite the openings, the strength of the flow can drop such that the particles partially deposit on the tray edge and on a cutting groove of a tray receptacle. The particles that become deposited on the tray edge, which in part serves as a sealing surface, can lead to defects in the seal and therefore lead to the discarding of non-useable packages. Deposits in the cutting groove can accumulate during on-going operation and cause problems or higher loads during the cutting process.

### SUMMARY OF THE INVENTION

One object of the present invention is to provide an improved tray sealer which eliminates the aforementioned problems.

The tray sealer according to one embodiment of the present invention comprises a sealing tool lower part with a tray receptacle and a sealing tool upper part, where the tray receptacle comprises a cutting groove being provided circumferentially around each opening for a tray in the tray receptacle. The tray receptacle can comprise at least one inlet opening and at least one outlet opening facing the cutting groove for flushing the cutting groove with gas. This results in a gas flow within the cutting groove which conveys foreign particles, such as herbs or small product residues that have deposited in the cutting groove, in the direction toward the outlet opening and further through this opening into the interior of the sealing tool lower part below the tray receptacle or from the tool lower part directly to the exterior, for example, into a collection container. Fouling or contamination of the tray receptacle and also of the sealing surface at the tray edge is thereby prevented or at least greatly reduced.

The inlet opening and the outlet opening may be located below a tray support of the tray receptacle in order to optimize the gas flow in the cutting groove, so that the cutting groove can act as a channel for the flow from the inlet opening all the way to the outlet opening.

The inlet opening and the outlet opening can have an orientation that is parallel to each other, since at least three sides of the cutting groove are in rectangular trays cleanable with a U-shaped flow.

In one embodiment, the inlet opening has a cross-sectional area of 20 to 50 mm² and/or the outlet opening has a cross-sectional area of 30 to 80 mm², where the inlet opening can also comprise a plurality of bores having the cross-sectional area specified. This configuration provides, firstly, for an effective gas flow and, secondly, for optimized discharge conveyance of the particles from the cutting groove through the outlet opening.

A line may be provided within the tray receptacle from the outlet opening downwardly into an interior of the sealing tool lower part. Particles or fouling carried along by the gas flow can be discharged via the line.

The tray receptacle can comprise multiple gas introduction openings and evacuation openings for introducing gas or flushing a respective tray or the space within the tray, respectively, with gas. The gas introduction openings may be provided above a plane defined by the tray support in order to efficiently create a modified atmosphere in the interior of the tray or the package, respectively.

The inlet opening and the outlet opening can each be arranged on a common side with the gas introduction and evacuation openings, as no or only very minor undesirable deposits of particles in the cutting groove and on the tray edge may occur on this common side. All openings may comprise a common parallel alignment.

A method according to one embodiment of the present invention for cleaning a cutting groove of a tray sealer described above is characterized in that gas is introduced prior to sealing and/or during sealing through the inlet opening into the cutting groove and this gas is at least in part discharged through the outlet opening from the cutting groove in order to entirely or in part remove particles or foreign objects that are located in the cutting groove. The gas may be oxygen, nitrogen, mixtures of both, air, or other gases or gas mixtures.

The flow path of the gas within the cutting groove may be largely congruent to the flow path of the gas for flushing the tray in order to prevent turbulence and to cause effective cleaning of the sealing surface on the tray edge.

Other and further objects of the invention, together with the features of novelty appurtenant thereto, will appear in the course of the following description.

### DESCRIPTION OF THE SEVERAL VIEWS OF THE DRAWING

In the following, an advantageous embodiment of the invention is further illustrated using a drawing, where:

FIG. 1 is a side perspective view of a tray sealer according to one embodiment of the present invention;

FIG. 2 is a schematic sectional view of a sealing tool lower part and the sealing tool upper part according to one embodiment of the present invention;

FIG. 3 is a sectional view of a tray receptacle according to one embodiment of the present invention; and

FIG. 4 is a schematic view of a tray receptacle according to one embodiment of the present invention.

Same components are throughout the figures designated with the same reference numerals.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

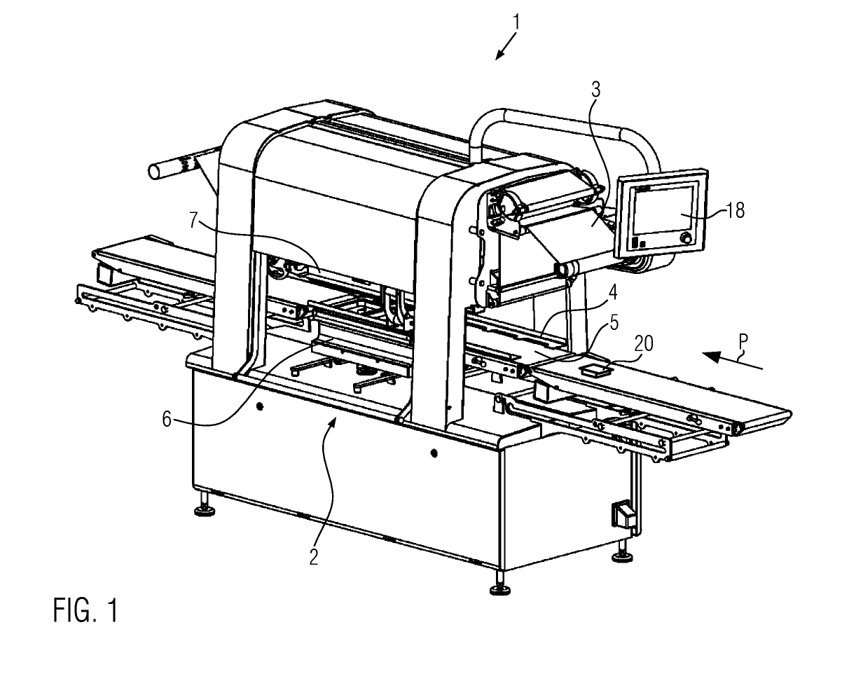

FIG. 1 shows an example of a tray sealer 1 with a sealing station 2, which seals trays 20 with a top film 3, and a gripper system 4 which moves trays 20 in a transport direction P from a feed conveyor 5 into sealing station 2. Sealing station 2 can comprise a sealing tool lower part 6 and a sealing tool upper part 7 disposed thereabove. Controller 18 may control and monitor all processes in tray sealer 1.

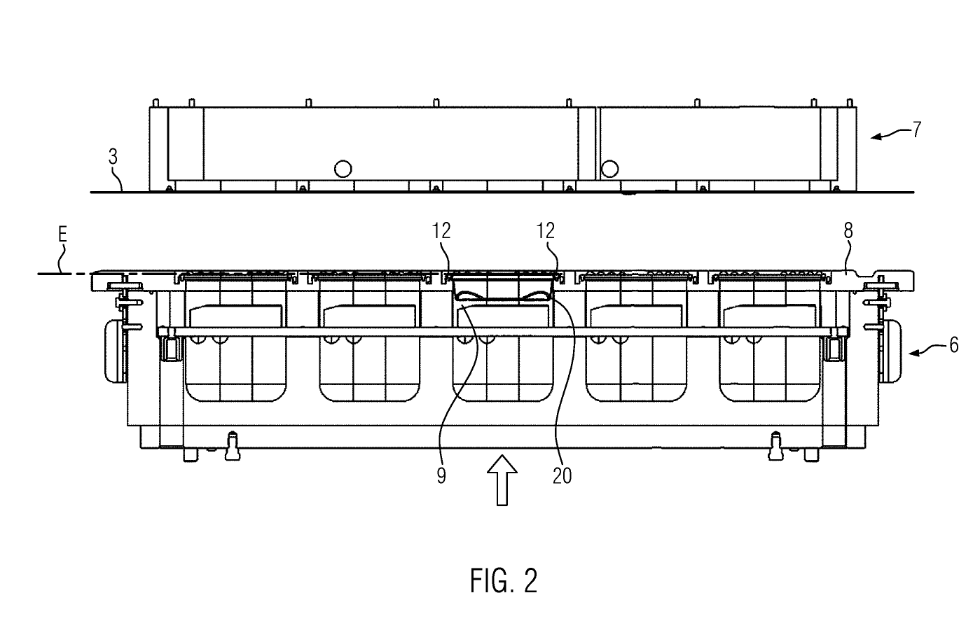

FIG. 2 shows a vertical sectional view of sealing tool lower part 6 with a tray receptacle 8 and sealing tool upper part 7 in the open position. A tray 20 is illustrated in a central opening 9 of tray receptacle 8. Top film 3 is illustrated on the underside of sealing tool upper part 7. Sealing tool lower part 6, together with tray receptacle 8 and tray 20, by way of a lifting mechanism (not shown in more detail) is movable upwardly in the direction of the arrow toward top film 3 and sealing tool upper part 7. Tray receptacle 8 may comprise one tray support 12 for every tray 20 which defines a plane E.

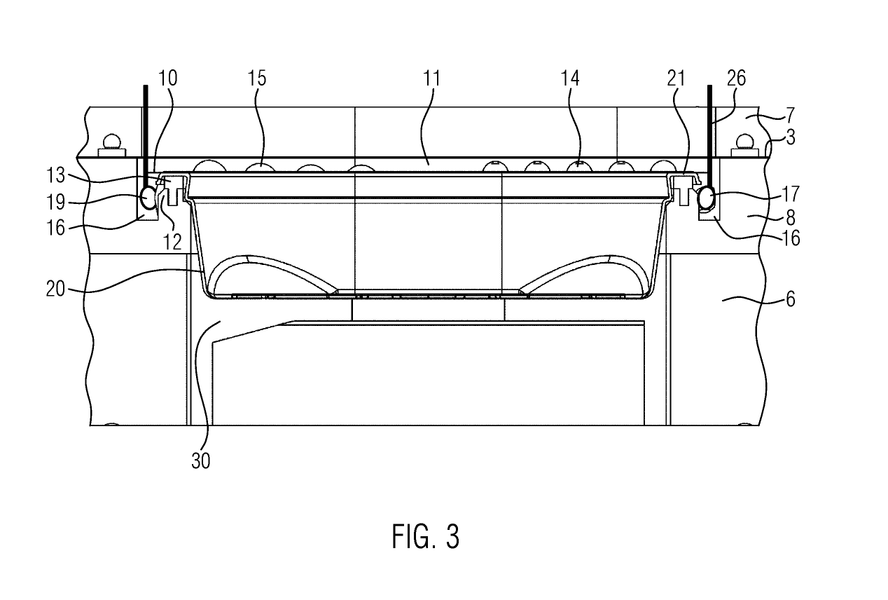

FIG. 3 shows a detailed view of the central region of tray receptacle 8 with tray 20 and a film section 10 already separated from top film 3, where sealing tool lower part 6 and sealing tool upper part 7 are now in a closed position and may form a gas-tight chamber 11 around tray 20 in order to evacuate and/or introduce gas into the interior of tray 20, namely, to create a modified atmosphere. Tray receptacle 8 for accommodating tray 20 or tray edge 21, respectively, may comprise a tray support 12 which can include a silicone seal 13 for the purpose of sealing. Sealing tool lower part 6 comprises an interior space 30 below tray receptacle 8 or below tray 20, respectively.

This sectional view of FIG. 3 shows five gas introduction openings 14 at the right behind tray 20 and four evacuation or outlet openings 15 at the left which are disposed at least in part above tray support 12 to generate a flow across tray edge 21 and tray 20. Tray receptacle 8 can comprise a respective cutting groove 16 extending circumferentially around opening 9 of tray receptacle 8 and around tray support 12, respectively. In the rear right area of the drawing plane or cutting groove 16, respectively, an inlet opening 17 for supplying gas into cutting groove 16 may be provided. In the rear left area an outlet opening 19 for discharging the gas may be provided. Inlet opening 17 and outlet opening 19 can be disposed completely below plane E of tray support 12. FIG. 3 also schematically shows a blade 26 which cuts out film section 10 from top film 3 prior to, during, or after sealing and may extend downwardly into cutting groove 16.

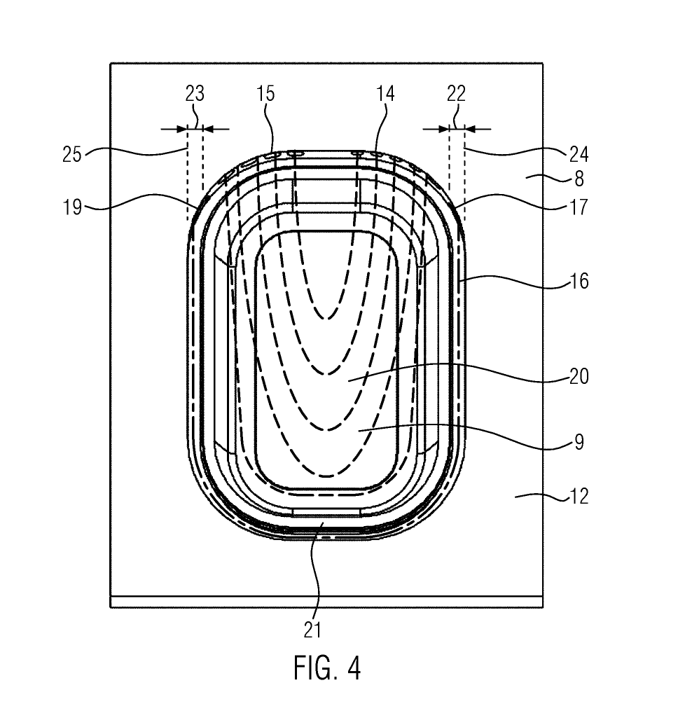

FIG. 4 shows an isometric view of tray receptacle 8 with opening 9, tray support 12, and cutting groove 16. The gas flow, which can be generated via five gas introduction openings 14 and four evacuation openings 15, is illustrated by way of dashed lines. This U-shaped gas flow ensures modification of the atmosphere of the interior of tray 20, for example, to minimize the amount of oxygen in order to give a food product to be packaged a longer shelf life.

A gas flow, in FIG. 4 being illustrated as a dashed-dotted line and generated in cutting groove 16 via inlet opening 17 and outlet opening 19, provides for removal of particles or small product residues that have deposited on tray edge 21 or in cutting groove 16 in order to clean in particular the sealing surface of foreign objects such as particles or small product residues prior to sealing on film section 10.

Inlet opening 17 can have a cross-sectional area 22 which corresponds to the cross section in a supply line 24. Similarly, outlet opening 19 can have a cross-sectional area 23 which corresponds to the cross section in a line 25. Line 25 can extend such that the escaping gas and the particles pass downwardly into interior space 30 of sealing tool lower part 6 and can be collected therein.

The inlet opening 17 or outlet opening 19, respectively, may alternatively comprise a plurality of bores or openings with a cross-sectional area that corresponds to the above-mentioned inlet opening 17 or outlet opening 19, respectively.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions and methods described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The teams “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. Tray sealer comprising:
a sealing tool lower part with a tray receptacle; and
a sealing tool upper part;
wherein the tray receptacle includes at least one opening for every tray and a cutting groove provided circumferentially around each respective opening in the tray receptacle;
wherein the tray receptacle further includes at least one inlet opening facing the cutting groove and at least one outlet opening facing the cutting groove for flushing the cutting groove with gas.

2. Tray sealer according to claim 1, wherein the inlet opening and the outlet opening are disposed below a plane of a tray support of the tray receptacle.

3. Tray sealer according to claim 1, wherein the inlet opening and the outlet opening have an orientation that is parallel to each other.

4. Tray sealer according to claim 1, wherein the inlet opening has a cross-sectional area of 20 to 50 mm² and the outlet opening has a cross-sectional area of 30 to 80 mm².

5. Tray sealer according to claim 1, wherein a line is provided within the tray receptacle from the outlet opening downwardly into an interior space of the sealing tool lower part.

6. Tray sealer according to claim 1, wherein the tray receptacle comprises a plurality of gas introduction openings and evacuation openings each for introducing gas or flushing a tray with gas.

7. Tray sealer according to claim 6, wherein each of the gas introduction openings and the evacuation openings is at least in part provided above a plane which is defined by the tray support.

8. Tray sealer according to claim 6, wherein the inlet opening and the outlet opening are each arranged on a common side of the tray receptacle with the gas introduction openings and the evacuation openings.

9. Method for cleaning a tray sealer, the method comprising the steps of:
providing a tray sealer having a tray receptacle with at least one opening, a cutting groove provided circumferentially around the at least one opening, at least one inlet opening facing the cutting groove, and at least one outlet opening facing the cutting groove;
introducing gas into the cutting groove through the inlet opening prior to and/or during a sealing operation; and
discharging gas at least in part from the cutting groove through the outlet opening.

10. Method according to claim 9, wherein a flow path of the gas within the cutting groove is largely congruent with a flow path of gas for flushing the tray.
